(19) United States
(12) Patent Application Publication
(10) Pub. No.: US 2007/0273866 A1
(43) Pub. Date: Nov. 29, 2007

(54) Tension Measurement By Optical Means

(76) Inventor: Palitha Bandara, Leeds (GB)

Correspondence Address: KLARQUIST SPARKMAN, LLP, 121 SW SALMON STREET, SUITE 1600, PORTLAND, OR, 97204, US

(21) Appl. No.: 10/575,371

(22) PCT Filed: Oct. 11, 2004
(86) PCT No.: PCT/GB04/04308

§ 371 Date: Feb. 9, 2007

(30) Foreign Application Priority Data
Oct. 11, 2003 (GB) 0323906.8

(51) Int. Cl. G01L 1/24

(52) U.S. Cl. 356/35.5

(57) ABSTRACT

An apparatus and method for determining a tension in a target strand is disclosed. The method and apparatus provides a non-contact way for determining tension in any type of elongate element simply and efficiently.

The present invention relates to an apparatus and method for determining tension in an elongate element. In particular, but not exclusively, the present invention provides a non-contact method for determining the tension in a yarn or wire. The yarn or wire which forms a target strand may be stationary or moving.

The measurement of tension of yarns produced by or supplied to textile machines is important for related quality assurance and process control functions. While the term “yarn” is used in the following text by way of example it will be understood that the present invention is applicable to many varieties of target strands such as cords, braidings, cables or lines which are relatively strong or even rovings or slivers which are weaker. The term strand is therefore to be broadly construed since the present invention can provide a mechanism for determining the tension in any elongate element.

Physically, a yarn may consist of a number of continuous filaments or be spun out of relatively short fibres. As such a yarn may have a twist given to it and a degree of unevenness of cross section along its length. Spun yarns also have a certain amount of hairiness. Yarns are often dyed to impart to them a colour which is required by an ultimate product. On a textile machine the yarns move at some speed ranging from a few millimetres per second to tens of meters per second.

Tension measurement of a yarn is carried out over a suitable span usually between two yarn guides. Contact type tension measuring instruments are known which employ the well-known three-point measuring principle and these are most commonly used by the industry. This type of measurement is simple in that it gives a direct reading of the tension in the yarn. However the measurement suffers from a number of drawbacks the greatest of which is the significant measurement error introduced by frictional drag on the yarn caused by measuring tips. This can lead to considerable (5%-15%) measurement errors. Also the tension of a target strand may be affected by the intrusion caused by probe tips. Another disadvantage is that physical contact with the strand may abrade or otherwise damage the target. Another problem with this known technique is the need for mechanical manipulation for threading in of the yarn. Also difficulties may be experienced in measuring tension of moving thread lines.

It is an aim of the present invention to at least partly mitigate the above-mentioned problems.

It is an aim of embodiments of the present invention to provide a non-contact method for determining a tension in a target strand.

It is an aim of embodiments of the present invention to provide apparatus which can very conveniently be used to determine the tension in a running thread or a stationary thread.

According to a first aspect of the present invention there is provided a non-contact method for determining a tension in a target strand, comprising the steps of:

providing a plurality of radiation detecting elements each arranged to provide an output signal for indicating a level of radiation incident at a respective detecting element;

detecting radiation incident at said plurality of detecting elements when said strand vibrates;

repeatedly identifying one or more detecting elements providing an output indicating a predetermined characteristic; and

determining the tension in said strand responsive to which of said detecting elements are identified.

According to a second aspect of the present invention there is provided apparatus for determining a tension in a strand comprising:

a plurality of radiation detection elements each for providing an output signal responsive to a respective level of incident radiation;

means for identifying one or more of said detecting elements providing a respective output indicating a predetermined characteristic; and

means for determining the tension in said strand responsive to which of said detecting elements is identified.

Embodiments of the present invention provide the advantage that no physical contact is required on a strand to measure the tension in that strand. As a result there is no need for mechanical manipulation of the strand for the purpose of tension measurement and consequently physical contact which may abrade or otherwise damage the strand is obviated. The non-contact technique also means that errors in the measurement are much reduced over known techniques.

Embodiments of the present invention provide the advantage that the tension in a strand may be determined regardless of the slender optical profile of the strand and without a requirement for strong illumination. Also variations in the strand, for example in the case of yarn by twist and hairiness, has no effect upon the accuracy of the tension measurement.

Embodiments of the present invention will now be described hereinafter, by way of example only, with reference to the accompanying drawings in which:

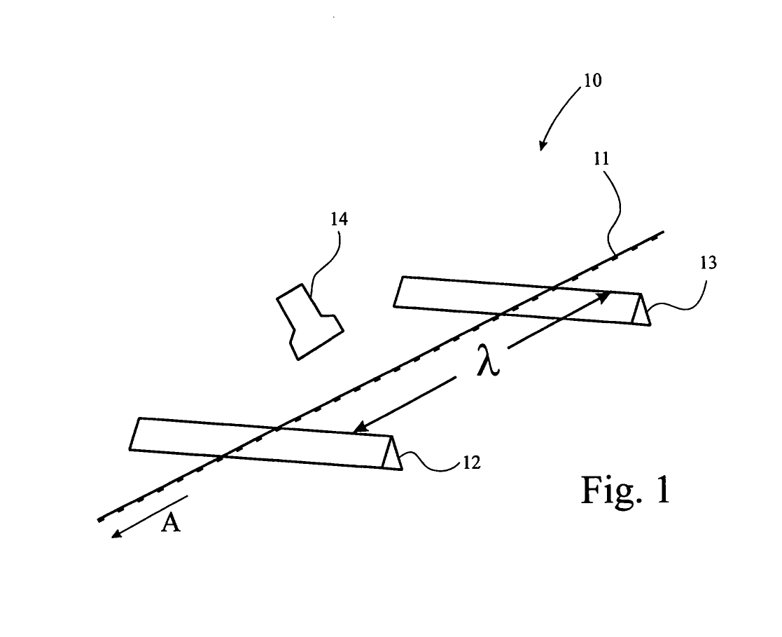

FIG. 1 illustrates a target strand;

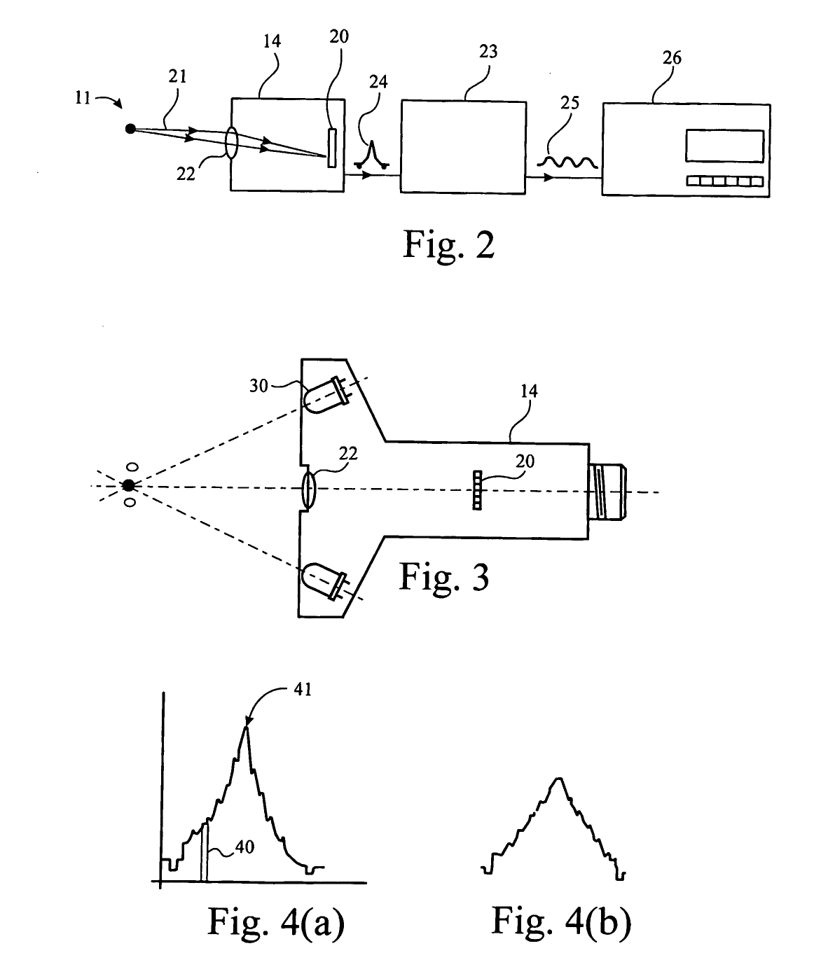

FIG. 2 illustrates analysing equipment;

FIG. 3 illustrates a sensing head;

FIG. 4 illustrates an output indicating a predetermined characteristic; and

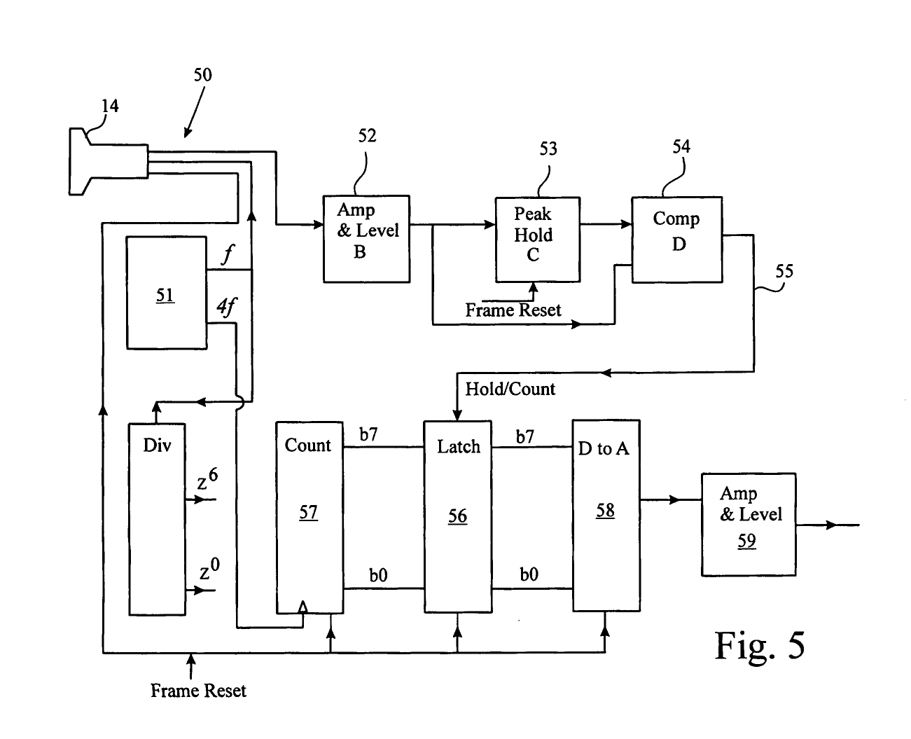

FIG. 5 illustrates an output signal analyser.

In the drawings like reference numerals refer to like parts.

FIG. 1 illustrates a location 10 in a textile yarn using environment. For example the location 10 may be a portion of a textile machine where yarns running at high velocity in the direction of arrow A in FIG. 1 are used to assemble manufactured products. Although reference is made here to the specific example of textile yarns it is to be understood that embodiments of the present invention are applicable wherever tension in an elongate element is to be determined. Such elongate elements forming a target strand may be cords, braidings, cables, monofilament fibres or rovings. The applications are not limited to items in this list. For stationary elements such as cables, a reflection aid such as a small strip of adhesive retro-reflective tape or high visibility paint can be placed on the element to aid detection.

The moving strand 11 moves over two spaced-apart strand supports 12 and 13. These help support and guide the yarn during its movement along a desired path. They also precisely define a distance e. As will be appreciated a textile yarn passing over two such guides is likely to undergo transverse vibrations at a frequency determined by its tension. Also a textile machine produces a certain amount of vibration in its operation and these tend to induce natural vibrations in open runs of the yarn found on it. Furthermore yarn motion aided by guide friction also tends to induce such vibrations. The frequency of such natural vibration has a clear relationship to the tension in the yarn as described later. This relationship has been known for a long time. However problems associated with detecting the tension satisfactorily have, until now, thwarted the realisation of a reliable general purpose non-contact yarn tension measuring instrument based upon that principle.

The apparatus for determining the tension in the target strand includes an optical sensing head 14 and associated electronic circuits for the detection of the lateral movement of the yarn due to vibrations and an electronic processing unit for data acquisition, analysis and display of tension readings. FIG. 2 illustrates this system schematically.

The sensor head 14 employs an optical sensor of the charge coupled device (CCD) linear array type 20. This includes 64 radiation detecting elements arranged in a predetermined array at a predetermined pitch. It will be understood that any type of array of detecting elements could be used. Radiation in the form of visible light (illustrated by lines 21 in FIG. 1) is focused on the CCD array by the lens 22. In certain situations/circumstances such as a fixed installation, infra red light may be used advantageously.

The radiation 21 illustrated in FIG. 2 is light provided by a light source (not shown) reflected from the yarn 11. It will be understood that embodiments of the present invention can be used in transmission as will be described hereinafter.

The CCD array 20 produces an output signal which is fed to a detection circuit 23. The signal 24 output from the detection circuit is detected and an output signal 25 is developed which corresponds the transverse positioning of the target strand. A signal processor 26 is then used to sample this signal repeatedly at a fixed rate and carry out frequency analysis on the acquired data so as to identify the natural frequency of a vibration of the target yarn. As the distance between the two yarn guides and the mean linear density of the yarn may be predetermined and thus known the tension of the yarn can be calculated by using the relationship:

$$f = \frac{n}{2 l} \sqrt{\frac{T}{ρ}}$$

Here f is the natural frequency of vibration, l is the distance between the strand supports, ρ is the linear density of the yarn, T is the tension in the yarn and n is an integer value corresponding to the mode of vibration of the strand. The fundamental natural frequency of the strand is normally encountered so n=1.

This equation is well known. Occasionally depending on the level of tension a higher harmonic vibration may be encountered. In order to avoid an incorrect determination of tension the apparatus can be set up to select the fundamental frequency (i.e. the first harmonic) as will be understood by those skilled in the art.

FIG. 3 illustrates a sensor head 14 in more detail. The sensor head includes a housing which supports the array of radiation detecting elements 20 and a lens 22. The yarn under measurement is illuminated by one or more high intensity light emitting diodes (LEDs) 30. In use, the sensor head is placed at a desired location proximate the yarn so that the image of the running thread line is formed on the CCD array by means of the lens based focusing arrangement. Accurate focusing is helpful but not essential. It is possible to incorporate an automatic focusing arrangement. Where two or more illuminating LEDs are used they can be so placed that their beams intersect at the correct position of the yarn with respect to the sensor head and lens. The LEDs could be of two or more colours so that when the beams cross the illumination would be of a different colour. Employing two or more indicator lamps driven from the detection circuitry can be helpful to achieve rapid positioning. This kind of arrangement is particularly useful when a handheld device is utilised. In such a hand held device the sensor head and analysis circuitry is supported in one simple handheld body.

It will be understood that embodiments of the present invention can be used without the need for specific fighting sources. Ambient light may be sufficient.

FIGS. 4a and 4b show a general form of the output from the CCD array. The wave form or frame shown is one complete sequential output available from the linear array. Each frame represents a snapshot in time of the radiation falling on the linear array. Each detecting element output is allocated a respective bin so that the output from one bin 40 corresponds to the output from a respective one of the detecting elements in the CCD array. The waveform is characterised by an initial brief dropping voltage level following the output sequence which corresponds to an internal reset operation of the output sequence. The signal may have a number of small peaks which may result from many external factors such as hairiness of the strand. However there is a major peak 41 which corresponds to the position of the yarn at a point in time when data is collected from the detecting elements. As the yarn vibrates its transverse position with respect to the sensor varies and this is observed in the varying position of the peak in successive frames of the wave form.

As this variation is proportional to the lateral movement of the yarn, the yarn vibration can be detected from the CCD output signal. As the detection is based on the position of the peak, and hence which element in the array and not the actual amplitude of the signal the determination is not affected by fluctuations of illumination level or the variation of reflected light due to reflectivity, hairiness or unevenness variations of the yarn. This is so as long as the level of illumination remains above a minimum level, so that the signal output is sufficiently high to enable the peak to be identified.

The peak 41 will be tall and sharp when the yarn is well focused on the CCD array as shown in FIG. 4(a). However when focusing is less sharp the waveform will be more similar to that illustrated in FIG. 4(b). However the position of the centre of the peak still indicates the position of the yarn. This allows some tolerance in the positioning of the sensor head with respect the yarn about the position for best focus. In a typical embodiment the variation of five millimetres on each side of the correct position in front of the focussing optics (at, for example, a focal length of seventy millimetres) is allowable. The output signals illustrated in FIG. 4 can be made to repeat at a rate of for example 1 kHz. This permits handheld use of the sensor since in a measurement period of one second about one thousand frames can be acquired.

At the normal tension levels encountered and range of yarn counts and span lens encountered textile yarns are found to vibrate at frequencies normally below 500 Hz. This suggests a minimum speed of 1 kHz for sampling the yarn vibration. The output signal amplitude from the CCD array essentially depends on the exposure time or the time per output cycle. A sampling rate of 1 kHz has been found to be acceptable although faster sampling rate may be used and for strands vibrating at frequencies substantially below 50 Hz a lower sampling rate may be used.

FIG. 5 illustrates a block diagram of circuitry used to develop a signal giving the yarn vibration information. The method described below measures the “distance” from the beginning of a frame to the position where the peak signal occurs by converting the corresponding CCD element number into an eight-bit word. Since exactly where the peak occurs can be known only at the completion of the frame (one must check the output of all bins before one knows which bin contains the maximum value) the output word is latched by stages during the last clock pulse of the output cycle of the CCD which may for example be a 64 detecting element device. In such a case 65 clock cycles are required to produce one frame of output as shown in FIG. 4. As illustrated in FIG. 5 a sensor head 14 is connected to the circuitry via a cable 50. It will be understood that for a handheld sensor the circuitry could be contained in the handheld device. Alternatively output values from the detecting elements in the sensor head could be sent to circuitry via a wireless interface. A quartz crystal based oscillator and divider circuit 51 is used to generate a clock signal to drive the CCD array. The divider divides a clock signal generated into selected clock signals as will be understood by those skilled in the art. For a 64 element array this frequency is required to be around 65 kHz so that a suitable near 1000 Hz frame output can be maintained. The actual frequency used is not critical although for very high frequencies intensity of incident radiation will be a problem unless a high intensity radiation source is used. The divider circuit associated with the crystal provides other timing signals required by different stages. An amplifier and level shift stage 52 amplifies the signals from the detecting elements to a desired voltage level. DC level adjustment is also permitted by this stage.

A peak detector and hold stage circuit 53 receives the sequential output bin by bin of a frame. The value of each bin is compared with a peak voltage value. For the first bin the value of the detecting element corresponding to that bin will be the peak value for that frame. The value of the next bin corresponding to the detecting element adjacent to the first detecting element is then compared with that pre-stored value. If the new bin has a higher value than the earlier bin or bins then a new high value is stored. In this way a voltage value corresponding to the peak 41 is detected and stored and output to a comparator 54. The comparator 54 compares the identified, so far, peak value of a frame with the bin by bin serial value output from the amplifier stage 52. In this way when a bin value is equal to the peak value so far for that frame the comparator output issues an enable signal on line 55. For a generally increasing slope as shown on the left hand side of FIG. 4(a) almost every new bin reading will be a new peak value and so the enable signal on line 55 will very often indicate a new peak value. However as will be described later the last enable signal which is issued for a frame indicates the true peak value and thus indicates which detecting element detects a peak incident radiation level. This last and significant enable signal transfers the output of counter 57, that corresponds to the transverse position of the yarn during the frame to the output of the latch 56. This value is held during the rest of the frame.

The latch 56 is continually supplied with an eight-bit digital count signal from counter 57 through bit lines B0 to B7. When a new frame is examined, indicating a snap shot of the location of a strand at any instant, the counter 57 is reset. In this way the counter stage is zeroed as each new frame of output signal is started. It thus counts the clock pulses continuously until the completion of the frame. Since it is an eight-bit counter the count can be in the range of 0 to 256 which is more than sufficient to count the 64 detecting element outputs. As such, arrays up to 256 elements can be accommodated by an 8 bit counter. As suggested by FIG. 5, for a 64 element array, the counter 57 can advantageously be clocked at 4 times the clock frequency applied to the detector array. In this way for a 64 element array a count value of 00010100 corresponds to detecting element number 5 from the start of the array. Since the pitch of the arrays is known this can indicate position. The latch 56 copies its input, which is the count produced by counter 57, each time it receives an enable signal from the comparator 54. It can be seen that after passing the highest peak in the signal which corresponds to the position of the strand during the current frame the latch just stops latching new values until the end of that frame. At the end of the frame a word output on bit lines B0 to B7 from the latch 56 indicates the detecting element detecting the highest incidence of radiation for a particular frame. This digital word signal is converted in a digital to analogue converter 58. Effectively the output from the latch provides on a scale of 0 to 256 a digital reading of the position of the vibrating yarn during the time interval of that frame. Issuance of a frame reset signal causes this reading saved in the latch to be transferred to the digital analogue converter so that at the end of the frame the converter output corresponds to the transverse position of the yarn during the corresponding time interval. Instead of being copied into the digital to analogue converter the output can be copied into an eight-bit latch which will give the same information digitally to be read directly into a data processor. The output from the digital to analogue converter 58 is amplified via an amplifier stage 59 and filtered to remove glitches. The output is the analogue of the transverse movement of the yarn. This output is represented by signal 25 in FIG. 2. The output signal is sampled precisely at 1000 Hz (or some other such frequency) by a data processor 26 such as a laptop, PC or DSP which is provided with suitable data acquisition hardware and processed using a Fast Fourier Transform routine to extract the frequency which has the highest signal amplitude which corresponds the yarn natural frequency. The frequency information so gathered together with predetermined yarn linear density and yarn span length may be used to calculate the yarn tension. The results can be displayed suitably according to the actual data processing arrangement used as will be understood by those skilled in the art.

In embodiments of the present invention the digital to analogue converter 58 stage is not used and the digital count is supplied directly to a data processor. In such a case it is necessary for the oscillator 51 to run at a precise frequency, for example 65 kHz for a CCD of 64 elements to provide 1000 Hz sampling rate and also possibly provide a synchronising pulse. The 65 kHz rate is useful when a CCD array texas instruments TSL 214 is utilised. It will be understood that other forms of detecting element array are applicable according to other embodiments of the present invention.

The tension of a yarn normally has a continuous variation and therefore the data captured over the measuring interval will reflect this variation. It is possible to take into account the signal amplitudes other than the highest to derive the profile of tension variation over a continuous measuring interval.

Embodiments of the present invention provide an instrument which is particularly suitable for measuring the average level of tension in textile yarns for process control purposes. The readings provided by the method compare well with those obtained by conventional methods. In fact since the non-contact methods are not affected by contact friction readings achieved more closely resemble true values. Embodiments of the present invention can be used as a handheld device or are suitable for machine mounted yarn tension monitoring involving single or multiple thread line situations.

Embodiments of the present invention provide a method and apparatus for detecting tension in a strand which may be very thin and perhaps too delicate for mounting any sensor directly onto. Also yarns in a moving state, sometimes many metres per second, can have their tension monitored.

Embodiments of the present invention can also provide a method and apparatus for determining the tension in a target strand which is non-metallic in nature which otherwise rules out the use of capacitive or magnetic sensing.

Although embodiments of the present invention have been described by way of example in a reflective mode it will be understood that a transmitive mode can be used whereby light obscured by a suitably located target strand is measured. In such circumstances a predetermined characteristic which is identified is the detecting element having the lowest level of incident radiation. This corresponds to the minimum rather than peak value. This also relates to a position when the strand is most directly between a light source and a detecting element array.

It will be understood that embodiments of the present invention need not identify just the maximum or minimum value from a detecting element array. It would be possible to detect any other predetermined characteristic. By using a linear optical detector detection in a horizontal axis can be achieved. This obviates the problems of prior known techniques in which variation in a vertical (amplitude) axis due for example to changes in detected values because of hairiness causes problems. Equally embodiments of the present invention provide a method and apparatus for determining the tension in a target strand which does not require strong illumination, which is not susceptible to a variation of the amount of reflected light caused by variations of yarn twist, reflectivity, cross-section and hairiness. Also 100 Hz flicker caused by fluorescent lighting is not unduly problematical.

Although embodiments of the present invention have been described with respect to a moving strand it will be understood that embodiments of the present invention are applicable to a stationary strand. The strand should have a vibration introduced into it for example by plucking or blowing on the strand at some location. In this way a natural resting position of the strand is interrupted and the detecting steps can be used whilst the strand returns to the resting position.

Embodiments of the present invention have been described above by way of example only. It will be understood that modifications may be made to the specifically described embodiments without departing from the scope of the present invention.

1. A non-contact method for determining a tension in a target strand, comprising the steps of:
providing a plurality of radiation detecting elements each arranged to provide an output signal for indicating a level of radiation incident at a respective detecting element;
detecting radiation incident at said plurality of detecting elements when said strand vibrates;
repeatedly identifying one or more detecting elements providing an output indicating a predetermined characteristic; and
determining the tension in said strand responsive to which of said detecting elements are identified.

2. The method as claimed in claim 1 further comprising the steps of:
providing a radiation source to illuminate a portion of said strand; and
detecting radiation reflected from said strand.

3. The method as claimed in claim 1 further comprising the steps of:
providing a radiation source to illuminate a portion of said strand; and
detecting radiation un-obscured by said strand.

4. The method as claimed in claim 1 wherein said step of repeatedly identifying comprises the steps of:
detecting a level of incident radiation at all of said plurality of detecting elements;
identifying which of said detecting elements from all of said plurality of detecting elements, has the highest level of incident radiation; and
repeating the steps of detecting a level of incident radiation at all of said detecting elements and identifying said highest level of incident radiation detecting element over a period of time.

5. The method as claimed in claim 1 wherein said step of repeatedly identifying comprises the steps of:
detecting a level of incident radiation at all of said plurality of detecting elements;
identifying which of said detecting elements from all of said plurality of detecting elements has the lowest level of incident radiation; and
repeating the steps of detecting a level of incident radiation at all of said plurality of detecting elements and identifying said lowest level of incident radiation detecting element over a period of time.

6. The method as claimed in claim 4 further comprising the steps of:
providing an output indicating the position of an identified detecting element over said period of time; and
determining a frequency associated with a change in position of said identified element.

7. The method as claimed in claim 6 further comprising the steps of:
calculating said tension according to the equation
T=ρ(2lf/n)²
where T is the tension in the strand, ρ is the linear density of the strand, l is the distance between two points of the strand, f is the natural frequency of vibration and n is an integer value corresponding to the mode of vibration of the strand.

8. The method as claimed in claim 1 further comprising the steps of:
supporting said strand at two spaced-apart locations via a pair of guide supports.

9. The method as claimed in claim 8 further comprising the steps of:
generating a vibration of said strand by running said strand in a direction parallel to a main axis of the strand and across guide supports arranged substantially perpendicular to the direction of running.

10. A method as claimed in claim 8 further comprising the steps of:
generating a vibration of said strand by displacing a portion of said strand away from a resting position and permitting said strand to recover to the resting position.

11. The method as claimed in claim 2 further comprising locating said strand at a desired location with respect to said plurality of detecting elements prior to determining said tension.

12. The method as claimed in claim 11 further comprising the steps of:
providing two or more radiation sources and locating said strand at said desired location by the steps of:
locating said plurality of detector elements at various locations with respect to said strand;
detecting when an intensity of reflected or transmitted radiation reaches a predetermined level;
selecting a position for said plurality of detector elements when the intensity reaches said predetermined level; and
locating said plurality of detection elements at said selected position.

13. Apparatus for determining a tension in a strand comprising:
a plurality of radiation detection elements each for providing an output signal responsive to a respective level of incident radiation;
means for identifying one or more of said detecting elements providing a respective output indicating a predetermined characteristic; and
means for determining the tension in said strand responsive to which of said detecting elements is identified.

14. The apparatus as claimed in claim 13 further comprising:
a radiation source for illuminating a portion of said strand.

15. The apparatus as claimed in claim 13 further comprising:
a lens for focussing radiation onto said radiation detecting elements.

16. The apparatus as claimed in claim 13 wherein said means for identifying comprises:
a comparator arranged to consecutively compare the output from the plurality of detecting elements with a repeatedly updated previously stored value and provide an enable signal to indicate when a detecting element provides a respective output indicating said predetermined characteristic.

17. The apparatus as claimed in claim 16 further comprising:
a data store arranged to store the repeatedly updated value.

18. The apparatus as claimed in claim 17 further comprising:
a counter arranged to output a running digital count signal, each value of said count signal indicating a respective one of said detecting elements.

19. The apparatus as claimed in claim 18 further comprising:
a latch arranged to receive said count signal and said enable signal and to output a count value responsive to said enable signal.

20. The apparatus as claimed in claim 13 wherein said means for determining the tension comprises:
a frequency analyzer for receiving a signal indicating said one or more identified detecting elements and, from said signal, determining a frequency of vibration of said strand.

21. The apparatus as claimed in claim 13 wherein said strand comprises a tensioned yarn.

22. The apparatus as claimed in claim 13 wherein said strand comprises a textile yarn.

23. The apparatus as claimed in claim 13 wherein said strand comprises a running strand.

24. The apparatus as claimed in claim 13 wherein said plurality of radiation detecting elements comprises a charge coupled device (CCD) or photodiode type linear array.

25. The apparatus as claimed in any claim 13 wherein said radiation source comprises one or more light emitting diodes.

26-27. (canceled)
